(19) United States
(12) Patent Application Publication
(10) Pub. No.: US 2007/0153638 A1
(43) Pub. Date: Jul. 5, 2007

(54) Motion sensor-triggered personalized message celebration device

(76) Inventor: Jody M. Lebbing, Annandale, NJ (US)

Correspondence Address: Kenneth P. Glynn, 24 Mine Street, Flemington, NJ, 08822, US

(21) Appl. No.: 11/325,918

(22) Filed: Jan. 5, 2006

(51) Int. Cl. G04B 21/00; G04B 19/00; G04B 25/00

(52) U.S. Cl. 368/274

(57) ABSTRACT

A motion sensor-triggered personalized message celebration device provides a personalized message to someone who is celebrating an event such as a birthday, graduation, holiday, holy day, wedding or the like. The present invention device offers a vehicle not heretofore used or suggested, namely, gift wrapping, bow, ribbon, bag or box or a celebration banner or pennant. The device includes a celebration accessory and a personalized message module and operates on a motion sensor to play back a message in a surprising manner to the recipient.

### BACKGROUND OF THE INVENTION

1. Field of the Invention

The present invention relates to devices that provide personalized messages to a recipient (especially a celebrant, such as a gift recipient or a party celebrant, honoree, wedding or other celebration-honored guest or recipient). A unique feature of the present invention involves the element of surprise. Typical personal message gift devices relate to cards or rely upon the recipient initiating a starter mechanism to play the message. The present invention devices, however, are mostly or completely hidden in wrappings, ribbons, packaging or banners and pennants, and are automatically started without a recipient needing to open a card or press a start button. Thus, the present invention devices utilize motion sensing as a triggering mechanism, and may be based on eternal proximity motion, or on motion of the device itself. Either way, the recipient is totally caught off guard and surprised to hear a personal message from a loved one, friend, relative, mate or the like when the device is activated automatically to play the message upon sensing motion.

2. Information Disclosure Statement

The following prior art id representative of the state of the art in the field of playback devices:

U.S. Pat. No. 6,718,013 B1 describes an audio message recording and playback system including a recorder-imprinter device, a self-contained voice module for playback of an audio message and a number of input devices for initially recording the audio message to the recorder-imprinter device.

U.S. Pat. No. 6,666,741 B1 describes a golf ball novelty item including a spherical housing having an exterior appearance of a golf ball and which is approximately the same size as a conventional golf ball. A motion sensor is provided in the interior compartment of the golf ball which senses human intrusion into a specified area around the housing. A voice producing and emitting means is operatively connected to the motion sensor so that the voice producing and emitting means will emit a predetermined message when a human intrudes into the specified area around the housing. Preferably, a ground stake is secured to the golf ball for anchoring the golf ball.

U.S. Pat. No. 6,628,789 B1 describes a talking toilet paper holder with a hollow toilet paper holding spindle having closed ends, one end having a compressible spring mounted shaft capable of inserting into a standard toilet paper roll holder, the opposite the end having a fixed shaft member extending the opposite ends' center capable of inserting into the opposite end of a standard toilet paper roll holder. An electronic digital recording and playback mechanism housed within said paper-holding spindle is activated by a record button flush with the surface of the hollow spindle. A power source such as a plurality of batteries is contained within said hallow spindle. A speaker is mounted flush with the inside wall of said opposite end of said spindle. A plurality of apertures in said opposite end enables a voice message to emit from said speaker through said end wall to the outer environment. A motion sensing switch and associated electronics causes a recorded message to play when said toilet paper holder is turned or otherwise moved.

U.S. Pat. No. 6,513,836 B2 describes a photo album includes front and rear covers, a volume of pages bound between the covers, each page for holding atleast one photograph, and an audio recorder for recording an audio message and playing back a recorded message. The recorder includes an electronic control circuit mounted on a printed circuit board affixed to one of the covers, and includes a memory device for storing recorded messages. The recorder includes a microphone and a speaker connected to the control circuit, the microphone and speaker inputting and outputting a message respectively, and at least one electrical switch supported by each separate page. The switch is associated with at least one photograph held by the same page and is connected to the control circuit for triggering the audio recorder to record or playback a message associated with the at least one photograph.

U.S. Pat. No. 6,439,723 B1 describes the present invention is an apparatus and method for presenting highly personal thoughts, sentiments, and engrams of a person in the form of a gift to a loved one. Feelings of an occasion or season are combined with a personal message through a representative embodiment of the season, for example, a Christmas ornament, having audio recording and image display devices therein. A simple photo transparency, such as a color side, or other image storage device projects the donor's image onto a screen, either formed in a case of a predetermined theme, or onto a wall, thus allowing the donor to simply and easily incorporate his or her own image, and voice, in a personalized way.

U.S. Pat. No. 6,253,183 B1 disclosed herein is a portable audio recording and playback system comprised of physically separate audio playback and external recording units, which are operably yet removably mateable. The audio playback unit has a power supply, audio storage, an audio playback device, an audio speaker, a first switch and a first connector all disposed in association the playback unit housing. The first switch prompts the audio playback device to playback at least one of the audio segments stored in the audio storage. The external recording units has a microphone, a second switch and a second connector all disposed with the recording unit housing. The first and second connectors are configured such that each is operably yet removably mateable to the other. The system also includes an audio recording device operably associated with the microphone and the audio storage and operably connected to the second switch toward prompting the recording device to record one of an audio segment. The audio recording device may be disposed in association with either of the playback unit or the recording unit. A novel manner for mounting the audio speaker within the playback unit housing is also disclosed.

U.S. Pat. No. 6,016,100 describes an animal deterrent system for deterring animal intrusion into a specified area using an oscillating ultrasonic tone. The system includes a weatherproof housing containing and infrared detector for detecting the presence of an animal. To identify relevant intrusions, a count of the number of detentions is maintained. After the count reaches predetermined number of infrared signals within a predetermined amount of time, an oscillating ultrasonic deterrent signal is generated to distress the animal and deter intrusion into the protected area. A deterrent timer activates the ultrasonic deterrent for a predetermined amount of time. A mounting stake for deploying the system in remote outdoor locations includes an anti rotation mechanism, to prevent misalignment as a result of incidental contact.

U.S. Pat. No. 5,973,250 describes the present invention involves a microelectronic device capable of audio playback and highlights, in conjunction with products such as a gift box or a “base” for nostalgia and memorabilia such as a gift or music box with its base and hingedly attached lid, or a base supporting and object of interest. A switch or light sensor or other actuation device is mounted in or on the base and is coupled to a circuit board also disposed in the base. The switch is open and the circuit is inactive when lid rests atop base, but the switch closes when the lid is open to activate the circuit board. In the alternative a manual switch, such as a press-button switch, may be used to activate the reply function. The circuit board, when activated, audibly reproduces “highlights”, which is audio information sufficiently long to cover a significant event, e.g., a portion of a political speech, a play from a sporting event, a climatic point of a drama or movie, or a broadcast news event yet short enough not to take an inordinate amount of time from the present. Further, the “highlights” should be able to be played in a multiple, consecutive or semi-random order. A ROM chip digitally stores a plurality of highlights which are retrieved and audibly reproduced by a processor on the circuit board when actuated by the switch. The circuit board may be disposed in a gift, music or keepsake box, sports and entertainment memorabilia, cards, frames, statuettes, bases, clocks, and similar items.

U.S. Pat. No. 5,894,275 describes a record/playback module a case and an electronic circuit supported by the case for recording an audio message under control of a user and thereafter automatically playing the audio message in response to a change in ambient light. The electronic circuit has a RECORD mode of operation in which the electronic circuit records the audio message and a PLAY mode of operation in which the electronic circuit plays the audio message. The electronic circuit includes a first switch initiating the RECORD made of operation and a light sensitive subcircuit for initiating the PLAY mode of operation. The light sensing subcircuit is adapted to initiate the PLAY mode of operation when a second switch is in a FIRST switch position and the ambient light increase, and when the second switch is in a second switch position and the ambient light decreases. One embodiment includes a battery power supply, an on-off switch, a light emitting diode indicating the RECORD mode of operation, and a case having a size and shape suitable for placement in a user's refrigerator with a reminder message that plays when the refrigerator door opens.

U.S. Pat. No. 5,886,613 describes a new barking dog sound alarm system for scaring away intruders using the menacing sounds of a dog. The device includes a microphone for detecting noise, a device to compare the detected noise level to a reference level so as to determine whether the detective noise is a potential intruder, a plurality of sound recordings of different excited dogs, a speaker for broadcasting one of the recordings, and a controller for activating one of the sound recordings when the detected noise is determined to be a potential intruder.

U.S. Pat. No. 5,719,920 describes a communication package has, enclosed in a storage disc, a voice chip connected by power input bus terminals to a renewable battery power system which provides easy battery accessibility. The storage disc preferably contains an acoustically resonant chamber and diffusion apparatus and preferably contains a removable barrier between the power system and the power system and the power input bus terminals that must be removed before the voice chip can be energized. A unitized interface system is used to store a voice message in the communication package by recording the voice message, replaying the voice message, optionally re-recording at least a portion of the voice message until the replay is satisfactory and converting the voice message to compressed, a digital “sound file”. Identifying information is encoded and converted into a compressed, digital “text file” and combined with the “sound file”. The identifying information is separated from the combined files and is displayed or printed. Only the contents of the communication package.

U.S. Pat. No. 5,322,717 describes an animated ornament fixture for installation in a garden or similar outdoor area frequented by visitors. Upon the approach or an observer, the fixture commences operation to surprise and entertain by elevating a decorative flowerpot to reveal a small figurine beneath, and optionally emitting sounds, and after departure of the observer, the fixture ceases operation.

U.S. Pat. No. 5,063,698 describes in one embodiment, the personalized greeting cards includes an independent, detachable, electronic memory device, a voice synthesizer which obtains these electronic signals and produces audible sounds representative of the personalized message, and a switch that controls the retrieving device and the voice synthesizer. Prior to incorporating the memory device in the card, an EPROM translation machine converts the personalized message obtained from the sender of the card into appropriate electronic signals in the memory device. The memory device is then detached from the EPROM and mounted in the circuitry disposed in the greeting card.

U.S. Pat. No. 5,045,327 describes a Digital Recording Center having a removable playback module for permanently capturing a human voice or other sounds into a compact module for playback within a greeting card or photograph. A recording center having a microphone (or other audio input device) is used to record a brief message, in a digital fashion, for loading into a playback module. Before loading the message into the playback module, the customer may listen through a speaker to determine if his message as recorded sounds proper. If the temporarily recorded message is in good form, the customer activates a transfer command button and the message is non-volatility stored in the removable playback module. The playback module may be placed into a compartment within a greeting card or picture, ornament, a stuffed animal or doll, or even a dog tag.

U.S. Pat. No. 4,702,140 describes small ornaments and novelties that emit music and other sounds (such as simulated voice) when exposed to light, and can be placed out-of-doors in a garden. Being light-powered, they can operate for an essentially indefinite time, even though unattended. Each such ornaments or novelty consists of a thematically configured body and a three-element working module sealed in a watertight can. It has no input keyboard or other terminal, and no display panel or other electronic or visual data output, except the audio output. Elements are a circuit, preprogrammed to produce electronic oscillations corresponding to a tune or other sounds preestablished at the manufacturer, a speaker receiving the oscillations and emitting the sounds, and a solar panel powering the circuit. The speaker shuts off if light is inadequate for completely correct operation, and otherwise is amplitude modulated by the light level.

Notwithstanding the prior art, the present invention is neither taught nor rendered obvious thereby.

### SUMMARY OF THE INVENTION

The present invention relates to a motion sensor-triggered personalized message celebration device to provide a personalized message to someone who is celebrating an event such as a birthday, graduation, holiday, holy day, wedding or the like. The present invention device offers a vehicle not heretofore used or suggested, namely, gift wrapping, bow, ribbon, bag or box or a celebration banner or pennant. Thus, the present invention device includes a celebration accessory and a personalized message module.

The celebration accessory is selected from the group consisting of a gift wrapping, a gift ribbon, a gift bow, a gift bag, a gift box, a banner and a pennant, and has a module securing means adapted to hold and conceal a personalized message module. The personalized message module is located at the module securing means and is a least partially concealed therein. The module at least has an electronic digital recording storage component, a playback mechanism including a miniature speaker or equivalent, a power source, a motion sensor and a motion sensor on/off switch. In some embodiments, the motion sensor is responsive to movement of the module such that when the switch is in on position and the module is moved, the motion sensor functions to sense movement of the module to automatically activate the playback mechanism. When the switch is in on position and a celebrant or recipient moves the device, the personalized message is automatically played back to surprise the celebrant or recipient. When the switch is in off position, the motion sensor does not function and the message will not play. Thus, a user, e.g. the giver of a gift, or the giver's agent, may keep the device module in the off position until the device is set for surprise activation, e.g. placed on a birthday table, or under a Christmas tree, or mounted or placed strategically, e.g., such as a banner or pennant placed on a wall or where a recipient or honoree will pick it up.

In another embodiment, the motion sensor is responsive to external movement within a predefined area from the module such that when the switch is in on position and the module detects external movement within the predefined area, the motion sensor functions to automatically activate the playback mechanism. Thus, when the switch is in on position and a celebrant or recipient moves near the device, the personalized message is automatically played back to surprise the celebrant or recipient.

In some embodiments, the device may play only once, or it may be designed for automatic or triggered play, as a designer may desire.

In some preferred embodiments, the motion sensor-triggered personalized message celebration device module securing means is in a generally concealed location on the celebration accessory and is selected from a pocket, a strap, a tape and an adhesive. However, other equivalent mechanisms may be used, such as a hook, a snap, a hook and loop (Velcro) system, a cord or other permanent or temporary attachment means.

In some preferred embodiments, the celebration accessory is connected to or surrounding a gift and is therefore selected from the group consisting of a gift wrapping, a gift ribbon, a gift bow, a gift bag and a gift box. This enables users to purchase the device and then attach it to any size, shape or type of gift that they may desire.

In some preferred embodiments, the motion sensor-triggered personalized message celebration device module includes an electronic digital recording mechanism with a miniature microphone, wherein a user may record a personalized message directly onto the module. Hence, it is a stand-alone device that requires no other support or ancillary equipment. In other preferred embodiments, the module includes a digital recorder connection means and digital recording receiving means wherein in a user may record a personalized message on a digital recorder and the personalized message may then be digitally transferred to the digital recording storage component of the module. The digital recorder may be in any format, such as one accessed with or included in a computer, home phone, cell phone, PDA, recorder or dedicated device solely for this purpose. Connection between the present invention device may be by wire or wireless connection. Although a simple plug in connection would presently be far less expensive than wireless connection.

In some preferred embodiments, the motion sensor-triggered personalized message celebration module has a single housing or a fitted housing. Most preferred is a substantially flat housing that contains all module components. This renders the device compact and easy to secure to the celebration accessory in a concealed fashion.

In some embodiments, the module is a one use only device and may be permanently secured to the celebration accessory and subsequently discarded after use. In other preferred embodiments, it may be reused with different messages and even different celebration accessories and is only temporarily or removably attached to the accessory. The module securing means may be a temporary module securing means that permits removal and reuse of the module or the module securing means may permanently attach the module to the celebration accessory. Thus, for example, the present invention motion sensor-triggered personalized message celebration device securing means on the celebration accessory may be a pocket that is selected from the group consisting of a sealed pocket and an unsealed pocket. The term “pocket” as used herein means a cavity, flexible or not, into which the module may be partially or full placed.

In most preferred embodiments, the present invention devices have automatic “tape over” or controlled “tape over” capabilities, i.e. a recording user may listen to a recording and re-record if the message does not satisfy the user. Thus, typically a recording user may preview a recording and record the message over, as desired.

### BRIEF DESCRIPTION OF THE DRAWINGS

The present invention should be more fully understood when the specification herein is taken in conjunction with the drawings appended hereto wherein:

FIG. 1 illustrates a general schematic diagram of the present invention device functional features;

FIGS. 2, 3, 4 and 5 diagrammatically show various present invention personalized message module arrangements and features;

FIG. 6 shows one embodiment of an actual present invention personalized message module;

FIGS. 7 and 8 illustrate preferred embodiment present invention gift bag and gift box devices;

FIG. 9 shows another embodiment of an actual present invention personalized message module with a pull tab off/on switch;

FIG. 10 shows a partial rear view of one embodiment of a present invention personalized message device in the form of a banner;

FIG. 11 shows a front view of one embodiment of a present invention personalized message device in the form of a gift bow;

FIG. 12 shows a rear view of one embodiment of a present invention personalized message device in the form of a ribbon; and,

FIG. 13 shows a partial rear view of one embodiment of a present invention personalized message device in the form of a pennant.

### DETAILED DESCRIPTION OF THE PRESENT INVENTION

The present invention relates to devices that are gift-wrappings, coverings, containers and party decorations that provide personalized messages to a recipient, a celebrant, such as a gift recipient or a party celebrant, honoree, wedding or other celebration-honored guest or other recipient. The present invention involves the element of surprise and includes a playback mechanism for a recorded personalized message that, once turned on, will playback when the device is approached and/or picked up. This invention adds, fun, love, excitement, etc. to gift giving and celebrations by allowing the gift giver, either present or unavailable, to go beyond written words. For example, a gift on a table at a birthday party in New York from absent grandparents in Florida would look ordinary until the birthday child approached it or picked it up and surprisingly heard grandmother say “Happy Birthday Jenna! Grandma and Grandpa in Florida Love You. Have fun today and enjoy all of your presents!” or “Merry Christmas Whitney! Grandma and Grandpa Love You!”

Digital components for recording, storing and playing are well known, as demonstrated for example by the prior art patents cited above. The motion sensors may be of any available design, such as those taught in U.S. Pat. Nos. 5,322,717; 6,016,100 and 6,628,789 also all incorporated herein by reference in their entirety.

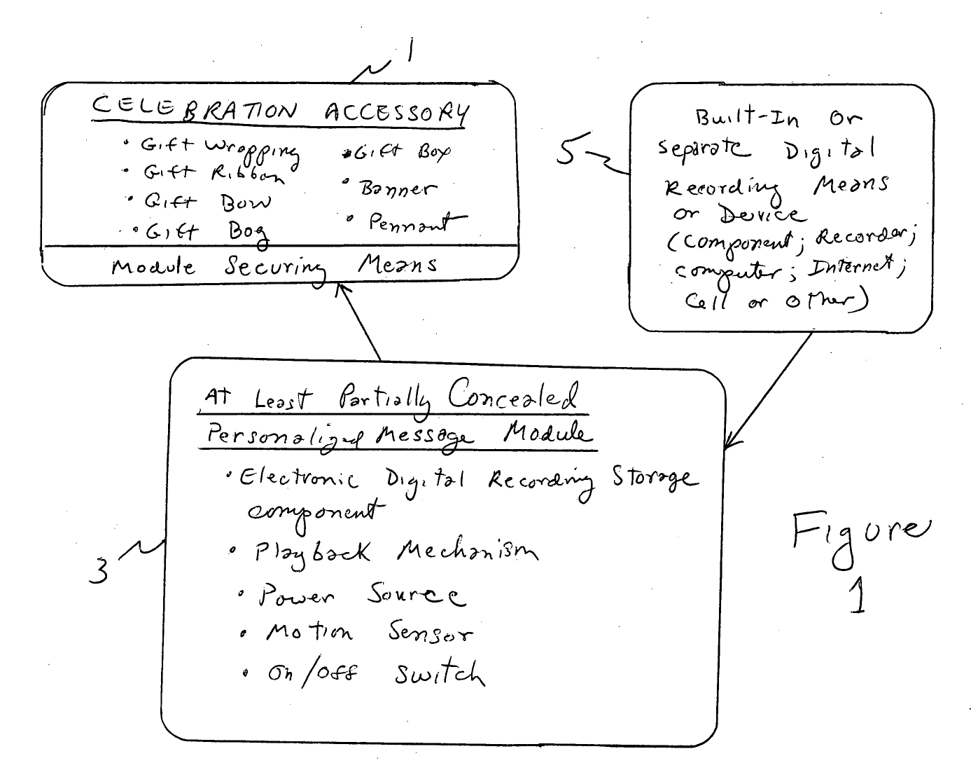

FIG. 1 illustrates a general schematic diagram of the present invention device functional features wherein a celebration accessory 1 has an at least partially concealed personalized message module 3 and a built in or separate digital recorder means 5 is provided. Details of each of these components are set forth in each block of the diagram in FIG. 1.

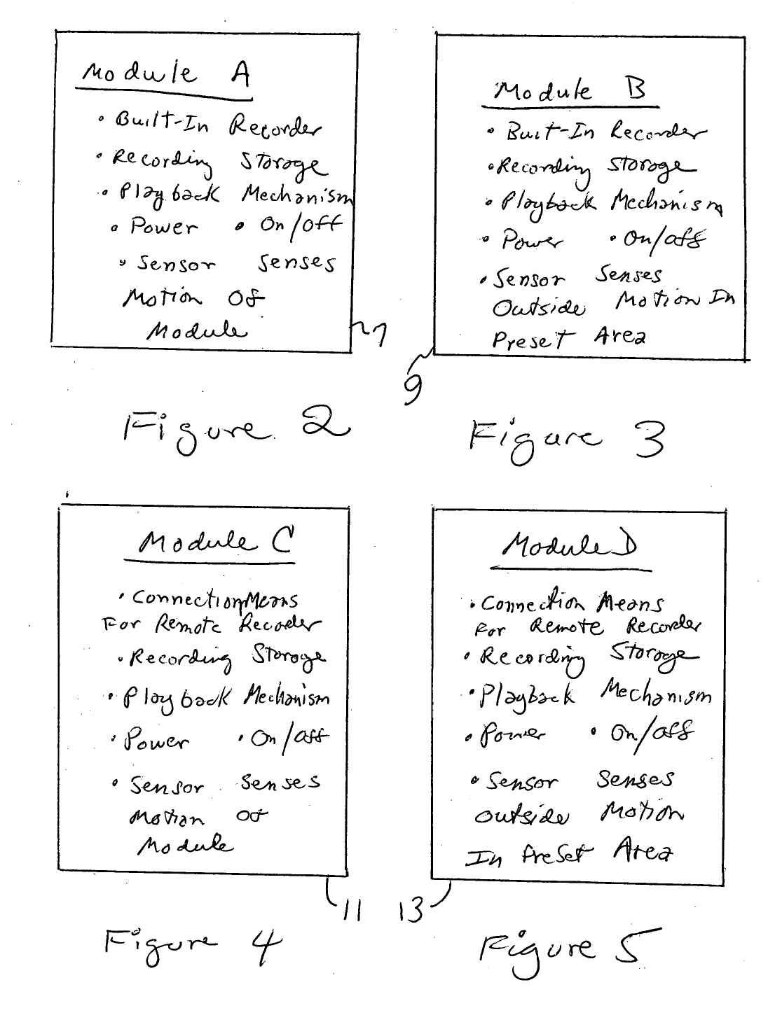

FIGS. 2, 3, 4 and 5 diagrammatically show various present invention personalized message modules A, B., C and D respectively. The arrangements and features of each are stated in blocks 7, 9, 11 and 13, respectively.

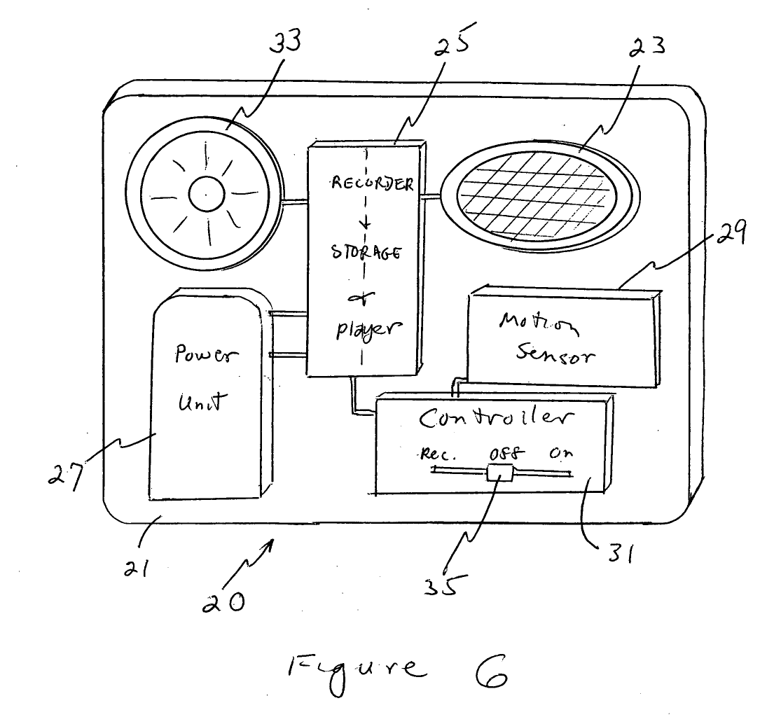

FIG. 6 shows one embodiment of an actual present invention personalized message module 20. Module 20 has a flat housing with a slotted cover removed (not shown, slotted to expose slider 35). Module 20 also has an integrated digital recorder, player and storage element 25 connected to speaker 23 for recording a personalized message. It could have sufficient storage to record a single message or a series of messages to be played back (to permit multiple family members, for example, to contribute to a message). Power unit 27 may be a fuel cell, a battery pack, a solar cell or otherwise, but is typically a storage cell or battery(ies), connected to drive element 25 to record or to play back the recording, as follows: Controller 31 may be set to record when slider 35 is moved to the “REC.” position. The “OFF” position will maintain storage. When slider 35 is moved to the “ON” position, only then will motion sensor 29 be on. When on and sensing motion, motion detector 29 will drive element 25 to automatically play the recorded message via miniature speaker 33 to surprise a recipient or honoree.

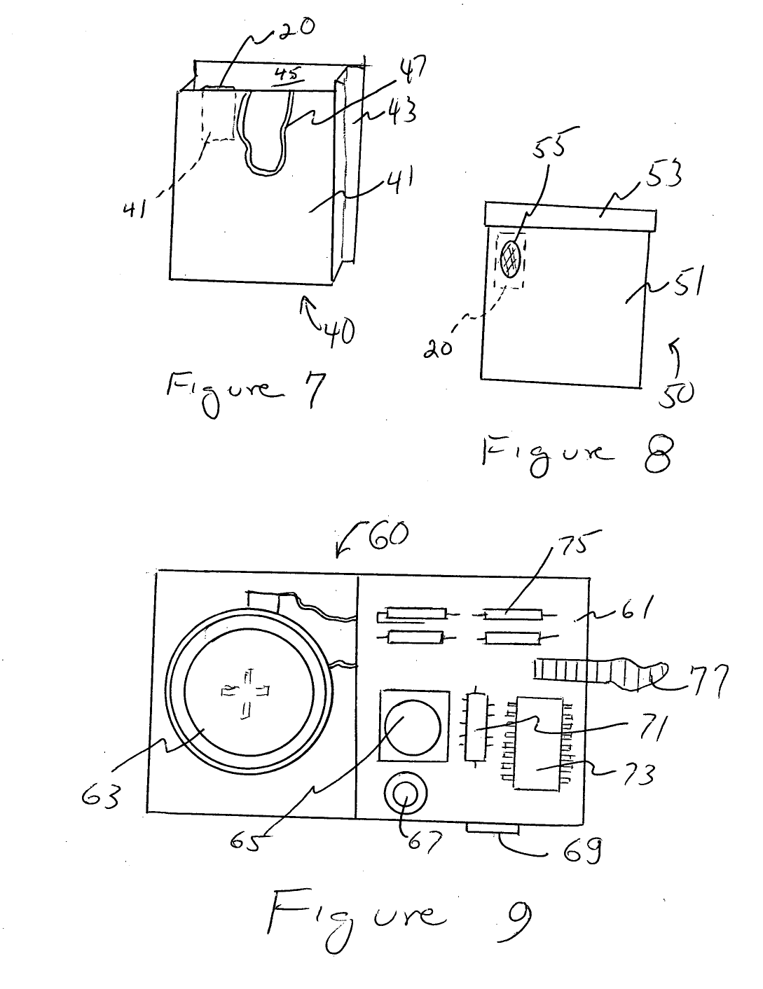

FIGS. 7 and 8 illustrate preferred embodiment present invention gift bag device 40 and gift box device 50, respectively. In FIG. 7, gift bag 40 has a typical gift bag shape with front 41, side 43, handle 47 and open top 45, for example. It also includes a pocket 41 inside the front top area that contains module 20 from FIG. 6 above. With the present inside and the gift bag 40 positioned strategically, the giver then turns on module 20 to turn on the motion sensor. When the recipient moves or approaches the bag 40 a surprisingly pleasant message is played back to the delight of the recipient.

Instead of honorees and gift recipients who are intended to be surprised with glee, in some situations a sender may have a somber, sad or even nasty message or send a practical joke type of message.

In FIG. 8, gift box 50 works similarly to bag 40 of the previous Figure, and includes a main box base 51 and a cover 53. There is a hidden attachment means inside base 51, as well as a speaker screen 55. This will play back the personalized message to the recipient upon motion detection when set as described above.

FIG. 9 shows another embodiment of an actual present invention personalized message module 60, this one having a pull tab off/on switch 77 that maintains the device in off position until it is pulled at which time it is on, but still needs to sense motion to play a message. In this embodiment, the message is recorded with a separate device and digital recording is sent by wire via port 69 to storage chip 73. Motion sensor 65 is a dual device that will sense both motion of the device and outside motion within a preset perimeter. When either motion is sensed and the device is turned on, playback and controller chip 73 will cause playback of the stored message via miniature speaker 65. Electronic components such as elements 65 and 75 are included to control sound filtering and storage space management. Battery 63 is the power source. The module 60 may have any shape and size, but flat credit card size and shape are preferred. A plastic housing may be provided in some embodiments while in others the module mat be affixed or sewn into a celebration accessory with only port 69 exposed.

FIG. 10 shows a partial rear view of one embodiment of a present invention personalized message device, as banner 80. Banner 80 has a cloth body 81 with hanging grommets 85 and a celebration message 87, as shown. It also has module 60 from FIG. 9 above removably secured in pocket 83 for use as described above. in this case, perimeter motion detection is preferred.

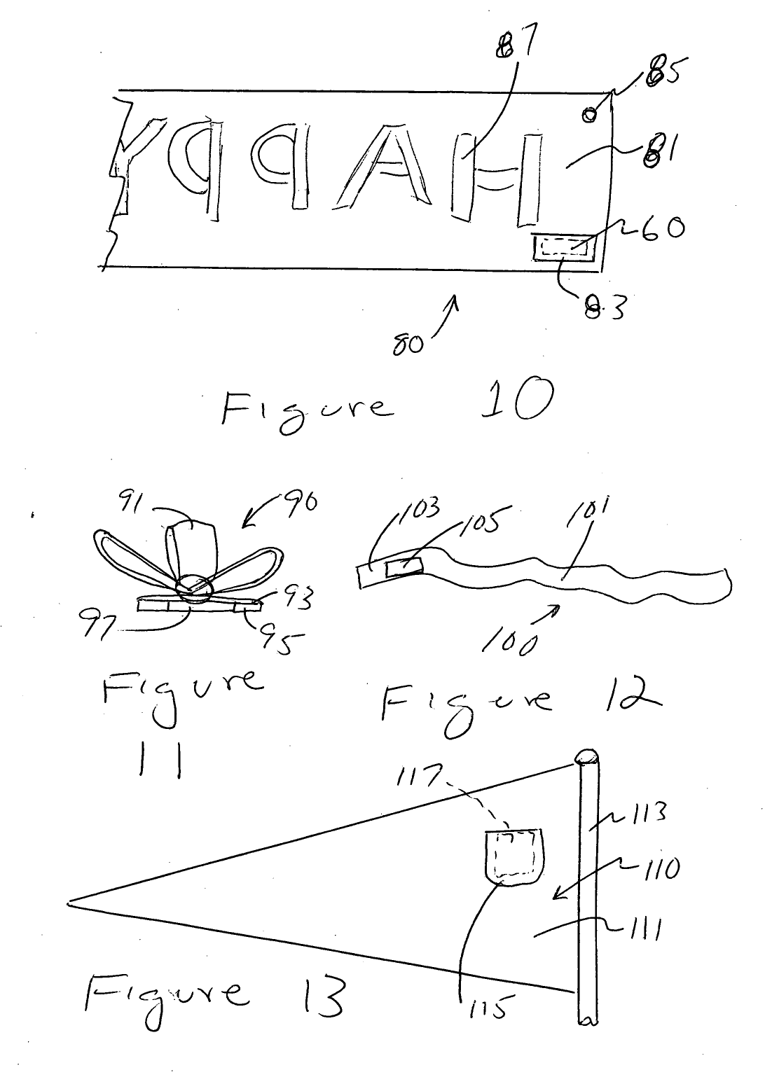

FIG. 11 shows a front view of one embodiment of a present invention personalized message device in the form of a gift bow 90. It includes a typical bow 91, an adhesive base 95 for securing to a gift or gift ribbon, and a present invention module 97 such as any of those described anywhere above.

FIG. 12 shows a rear view of one embodiment of a present invention personalized message ribbon 100 with its typical elongated ribbon fabric 101 and a secured personalized message module 105 attached at end 103, as shown.

FIG. 13 shows a partial rear view of one embodiment of a present invention personalized message pennant device 110. It includes pole 113, rigid fabric or sheet 11, typically with a message, logo, team or other information, and here includes a pocket with personalized message module 117 contained therein.

Obviously, numerous modifications and variations of the present invention are possible in light of the above teachings. It is therefore understood that within the scope of the appended claims, the invention may be practiced otherwise than as specifically described herein.

What is claimed is:

1. A motion sensor-triggered personalized message celebration device, which comprises:
a.) a celebration accessory selected from the group consisting of a gift wrapping, a gift ribbon, a gift bow, a gift bag, a gift box, a banner and a pennant, said celebration accessory having a module securing means adapted to hold and conceal a personalized message module;
b.) said personalized message module being located at said module securing means and being a least partially concealed therein, said module having an electronic digital recording storage component, a playback mechanism, a power source, a motion sensor and a motion sensor on/off switch, said motion sensor being responsive to movement of said module such that when said switch is in on position and said module is moved, said motion sensor functions to sense movement of said module to automatically activate said playback mechanism, and when said switch is in off position, said motion sensor does not function;
whereby, when said switch is in on position and a celebrant or recipient moves said device, the personalized message is automatically played back to surprise the celebrant or recipient.

2. The motion sensor-triggered personalized message celebration device of claim 1 wherein said module securing means is in a generally concealed location and is selected from a pocket, a strap, a tape and an adhesive.

3. The motion sensor-triggered personalized message celebration device of claim 1 wherein said celebration accessory is selected from the group consisting of a gift wrapping, a gift ribbon, a gift bow, a gift bag and a gift box.

4. The motion sensor-triggered personalized message celebration device of claim 1 wherein said module includes an electronic digital recording mechanism wherein a user may record a personalized message directly onto said module.

5. The motion sensor-triggered personalized message celebration device of claim 1 wherein said module includes a digital recorder connection means and digital recording receiving means wherein in a user may record a personalized message on a digital recorder and the personalized message may then be digitally transferred to said digital recording storage component of said module.

6. The motion sensor-triggered personalized message celebration device of claim 1 wherein said playback mechanism includes a miniature speaker.

7. The motion sensor-triggered personalized message celebration device of claim 1 wherein said module includes a substantially flat housing that contains all module components.

8. The motion sensor-triggered personalized message celebration device of claim 1 wherein said pocket is selected from the group consisting of a sealed pocket and an unsealed pocket.

9. The motion sensor-triggered personalized message celebration device of claim 1 wherein said module securing means is a temporary module securing means that permits removal and reuse of said module.

10. The motion sensor-triggered personalized message celebration device of claim 1 wherein said module securing means permanently attaches said module to said celebration accessory.

11. A motion sensor-triggered personalized message celebration device, which comprises:
a.) a celebration accessory selected from the group consisting of a gift wrapping, a gift ribbon, a gift bow, a gift bag, a gift box, a banner and a pennant, said celebration accessory having a module securing means adapted to hold and conceal a personalized message module;
b.) said personalized message module being located at said module securing means and being at least partially concealed therein, said module having an electronic digital recording storage component, a playback mechanism, a power source, a motion sensor and a motion sensor on/off switch, said motion sensor being responsive to external movement within a predefined area from said module such that when said switch is in on position and said module detects external movement within said predefined area, said motion sensor functions to automatically activate said playback mechanism, and when said switch is in off position, said motion sensor does not function;
whereby, when said switch is in on position and a celebrant or recipient moves near said device, the personalized message is automatically played back to surprise the celebrant or recipient.

12. The motion sensor-triggered personalized message celebration device of claim 11 wherein said module securing means is in a generally concealed location and is selected from a pocket, a strap, a tape and an adhesive.

13. The motion sensor-triggered personalized message celebration device of claim 11 wherein said celebration accessory is selected from the group consisting of a gift wrapping, a gift ribbon, a gift bow, a gift bag and a gift box.

14. The motion sensor-triggered personalized message celebration device of claim 11 wherein said module includes an electronic digital recording mechanism wherein a user may record a personalized message directly onto said module.

15. The motion sensor-triggered personalized message celebration device of claim 1 wherein said module includes a digital recorder connection means and digital recording receiving means wherein in a user may record a personalized message on a digital recorder and the personalized message may then be digitally transferred to said module digital recording storage component of said module.

16. The motion sensor-triggered personalized message celebration device of claim 11 wherein said playback mechanism includes a miniature speaker.

17. The motion sensor-triggered personalized message celebration device of claim 11 wherein said module includes a substantially flat housing that contains all module components.

18. The motion sensor-triggered personalized message celebration device of claim 11 wherein said pocket is selected from the group consisting of a sealed pocket and an unsealed pocket.

19. The motion sensor-triggered personalized message celebration device of claim 11 wherein said module securing means is a temporary module securing means that permits removal and reuse of said module.

20. The motion sensor-triggered personalized message celebration device of claim 11 wherein said module securing means permanently attaches said module to said celebration accessory.
